(19) United States
(12) Patent Application Publication
(10) Pub. No.: US 2018/0282551 A1
(43) Pub. Date: Oct. 4, 2018

(54) ADDITIVE METAL PATTERNS

(71) Applicant: Vast Films, Ltd., Darlington, PA (US)

(72) Inventor: Carl M. Finsted, Darlington, PA (US)

(21) Appl. No.: 15/937,354

(22) Filed: Mar. 27, 2018

Related U.S. Application Data
(60) Provisional application No. 62/477,223, filed on Mar. 27, 2017.

(51) Int. Cl. C09D 5/00; C09D 139/06; C09D 129/04

(52) U.S. Cl. CPC C09D 5/008; C08K 3/36; C09D 129/04; C09D 139/06

(57) ABSTRACT

The invention describes a release agent and process for the additive deposition of metal to a flexible film. A release agent can be coated onto the flexible film to produce a negative of a desired metal pattern. Optionally, the coated film can be rolled up and stored until needed. After deposition of at least one metal layer on the coated film, the release agent can be removed with water without the need for further degreasing. The release agent can comprise polyvinylpyrrolidone (PVP) or polyvinyalcohol (PVOH), and copolymers thereof. An anti-blocking agent reduces adhesion of the release agent to the inverse side of the film during storage. Advantageously, the release agent can be applied as a water solution using any convenient printing technique including, but are not limited to, flexographic, inkjet, silk-screening, and gravure

The present invention claims priority to U.S. 62/477,223 filed 27 Mar. 2017.

### FIELD OF THE INVENTION

The invention relates to a method of producing a metal pattern on a film substrate.

### BACKGROUND OF THE INVENTION

The production of a selective metal pattern on a flexible film can be a subtractive or additive process. The former begins with a film coated with a solid area of metal. A resistant coating is printed on the metal and the unwanted area of metal is removed using a metal etchant to form the metal pattern. The subtractive process leaves behind a metal pattern covered by the resistant coating. Electrically connecting with the metal pattern requires penetration of the coating. Increasing the thickness of the metal pattern after placing the resistant coating may not be possible.

An additive process generally involves coating a release agent onto the film before the metal is deposited. The release agent is printed as a negative image of the metal pattern to be created. At least one layer of metal is deposited onto release agent and the surface of the film. Subsequent removal of the release layer removes the metal that deposited on it, and results in the desired metal pattern. Advantageously, multiple layers of metal can be coated before removing the release agent. Further, the metal is exposed so that an electrical connection is not hindered by any coating.

Release layers can include oils or other low surface energy materials, such as fluorocarbons, that can be mechanically removed from the film. Release layers can also include materials susceptible to thermal degradation, chemical reaction, or solvation. Examples include materials that outgas during metallization, thereby resisting deposition of metal, salts that are dissolvable in water, whereby the metal that deposited on the salt is removed. Alternatively, release layers such as organic polymers, including for example cellulose acetate, can be dissolved in organic solvents to produce the metal pattern.

Several problems arise with the use of release agents. Commonly, the release agent must be applied immediately before deposition of the metal because the film cannot be rolled up without comprising the integrity of the release agent layer or contaminating the reverse side of the film. The film cannot be stored with the release agent in place unless the metal is deposited. This requires manufacturers to coat the release agent and deposit the metal pattern essentially simultaneously.

Release agents can also compromise the accuracy of the metal pattern and prevent deposition of a second metal pattern. For example, outgassing or heat sensitivity can contaminate or distort the metal pattern. Crystalline release agents, such as salts, can increase surface roughness or produce undesirable dendritic structures. Soluble release agents can require solvents that may attack the film, require excessive dissolution times, or leave an organic residue. Residual impurities can affect the metal pattern. Oil-based release agents or solvents generally must be removed before further processing. For example, a degreasing stage may be necessary to permit the soldering of electrical connections to the metal pattern. Residual salts can seriously impair electrical performance.

A need exists for release technologies of metal films that are based on materials that are inert and thermally stable over the range of operating conditions for these processes, and provide a smooth, homogeneous and amorphous surface for deposition. Preferably, the release agent could be applied to the flexible film and the film then rolled up for storage or transport without the need immediately to deposit the metal pattern.

### SUMMARY OF THE INVENTION

The object of this invention is to provide a release agent for an additive metal printing process that can be coated onto a film to produce a negative of a desired metal pattern. The release agent forms a coating that can be rolled up with the film without losing integrity or transferring to the inverse side of the film. Metal can later be deposited on the film, and the coating can then be removed with water or alcohol, whereby the remaining metal forms the desired metal pattern.

In embodiments, the release agent is a polymer that is soluble in water, alcohol, or combinations thereof. The polymer should form a continuous layer when applied to the film. The polymer is preferably sufficiently flexible and possessing of mechanical strength to roll up with the film while preserving the continuous layer free of cracks or voids. In embodiments, the polymer can remain a solid until at least about 50° C. Preferably, the polymer has a glass transition or melting point above that of the flexible film. For example, polyester films can have glass transitions of at least 75° C., so the polymer would preferably have a glass transition or melting point above this temperature. In further embodiments, the release agent comprises polyvinylpyrrolidone (PVP) or polyvinyalcohol (PVOH), and copolymers thereof. PVP and PVOH are water soluble and have melting points of at least 150° C.

The release agent can include a dye to identity film as coated. The release agent can also include an anti-blocking additive to better resist adhesion of the release agent to the inverse side of the film. Anti-blocking agents can operate physically or chemically. In embodiments, the anti-blocking agent comprises low particle size silica or other filler. Silica can include fumed silica or other silicas having a particle size less than about 25 microns and preferably less than about 10 microns.

In further embodiments, the release agent can be applied in solution using any convenient printing technique. Such techniques include, but are not limited to, flexographic, inkjet, silk-screening, and gravure.

### BRIEF DESCRIPTION OF THE DRAWING

FIG. 1 shows a metal pattern produced by the invention.

### DETAILED DESCRIPTION OF THE INVENTION

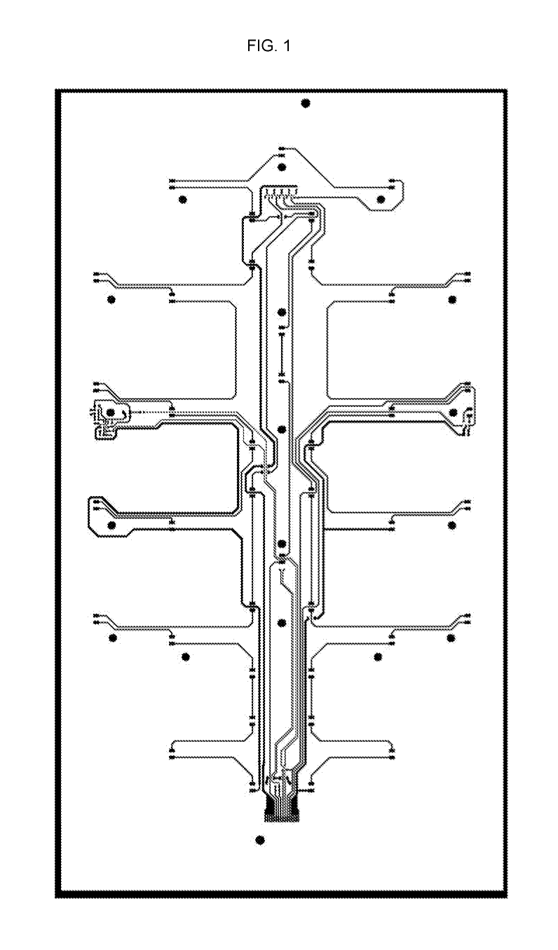

The invention includes a release agent for use in additive deposition of metal to a flexible film. The release agent comprises a polymer that is soluble in water, alcohol, or combinations thereof. The release agent is applied as a negative image of a metal pattern, and can be applied using any convenient method, including standard printing techniques. As shown in FIG. 1, these printing techniques can produce very fine metal patterns. The release agent is sufficiently strong and flexible that it can be rolled up with the film. The rolled-up film can be stored or transported so that the metal can be deposited at a convenient time. The release agent resists blocking during storage.

Additive deposition, as opposed to subtractive process, permits multiple layers of metal to be applied to the film. Increasing metal film thickness can improve conductivity and other properties of the metal pattern. Further, additive deposition leaves the metal exposed, which facilitates electrical connections and use as an antenna.

The release agent can be applied as a solution using any convenient printing technique. Such techniques include, but are not limited to, flexographic, inkjet, silk-screening, and gravure. After deposition of the metal, the release agent can be removed using only water, alcohol, or their combinations as a solvent. Removing the release agent can include passing the flexible film through a tank containing a suitable solvent comprising water, alcohol, or combinations thereof. The release agent can also be removed by spray rinsing. After removing the release agent, the flexible film can be dried using, for example but without limitation, an air knife or hot air. Unlike prior art oils or solvent-based release agents, water/alcohol solvents do not impair the integrity of the flexible film and require no degreasing.

The release agent should produce a uniform coating on the film, be flexible enough to be rolled up with the film, and be anti-blocking, that is, resist adhesion to the inverse side of the film when rolled. Anti-blocking can require the release agent to have a higher glass transition or melting point than the flexible film. In embodiments, the flexible film is a polyester with a glass transition of about 75° C., and the release agent comprises polyvinylpyrrolidone (PVP), polyvinylalcohols (PVOH), and copolymers thereof (collectively, PVP). Thin films of PVP are flexible and, with a melting point above about 150° C. when dry, PVP can resist blocking. Anti-blocking agents, such as inorganic powders, can further reduce blocking. Anti-blocking agents can include silica with a particle size less than about 25 microns and preferably less than about 10 microns.

Because the release agent can be rolled up with the flexible film, a dye can alert operators that the film has been pre-coated with a release agent. In embodiments, a dye is added to the release agent so that an operator will not attempt to add a second release agent before metal deposition.

### EXAMPLE 1

A PVP-based release agent was tested for anti-blocking. A release agent was prepared from 30 wt. % PVP, 0.5 wt. % dye, and a balance of water. Three other release agents were prepared using the same composition but with 1 wt. % silica with a particle size of 7.5, 6, and 3.5 microns, respectively. Each release agent was drawn down on four polyester flexible films using a #0006 wire rod to produce a dry thickness of 5 microns. The release agents were also drawn down on four polyester flexible films using a #0003 wire rod to produce a dry thickness of about 2.5 microns. The four films at each release agent thickness were stacked and a pressure of 4 psi was applied for 24 hours. At both release agent thicknesses, the release agent without the silica adhered to adjacent films, but the release agent with the silica showed little if any adhesion to the inverse side of the film.

The experiment was repeated but with the time under pressure increase to 90 hours. Again, the release agent with the silica resisted blocking while the release agent without the silica adhered to the adjacent film.

### EXAMPLE 2

A release agent was prepared from 30 wt. % PVP, 0.5 wt. % dye, 1 wt. % silica with a particle size of 3.5 microns, and a balance of water. The release agent was drawn down on four polyester flexible films using a #0003 wire rod to produce a dry thickness of about 2.5 microns. The four films were stacked and a pressure of 4 psi was applied for 24 hours at a temperature of 38° C. The release agent showed little if any adhesion to the inverse side of the film.

What is believed to be the best mode of the invention has been described above. However, it will be apparent to those skilled in the art that numerous variations of the type described could be made to the present invention without departing from the spirit of the invention. The scope of the present invention is defined by the broad general meaning of the terms in which the claims are expressed.

1. A release agent to produce selective metal patterns comprises a polymer that is soluble in a solvent selected from a group consisting of water, alcohol, and combinations thereof, and that is capable of producing a continuous layer and remaining a solid at temperatures above about 50° C.

2. The release agent of claim 1, wherein the polymer selected from a group consisting of polyvinylpyrrolidone (PVP), polyvinylalcohols (PVOH), and copolymers thereof.

3. The release agent of claim 1, wherein the release agent also includes a dye.

4. The release agent of claim 1, wherein the release agent also includes an anti-blocking agent.

5. The release agent of claim 1, wherein the anti-blocking agent comprises silica having a particle size less than 25 microns.

6. A release agent to produce selective metal patterns comprises:
a. a water-soluble polymer selected from a group consisting of polyvinylpyrrolidone (PVP), polyvinylalcohols (PVOH), and copolymers thereof;
b. a dye, and
c. an anti-blocking agent comprising silica having a particle size less than 10 microns.

7. A process for producing a selective metal pattern comprising:
a. Coating a polymer onto a flexible film as a negative image of a metal pattern, where the polymer is soluble in a solvent selected from a group consisting of water, alcohol, and combinations thereof;
b. Depositing at least one metal layer on the flexible film;
c. Dissolving the polymer from the flexible film, whereby the metal pattern remains.

8. The process of claim 7, further comprising coating the polymer onto the flexible film using a printing technique selected from the group consisting of flexographic, inkjet, and gravure.

9. The process of claim 7, further comprising rolling up the flexible film after coating with the polymer and before depositing the metal on the flexible film.

10. The process of claim 7, further comprising depositing a plurality of metal layers on the flexible film.
